(19) United States
(12) Patent Application Publication
(10) Pub. No.: US 2015/0165656 A1
(43) Pub. Date: Jun. 18, 2015

(54) APPARATUS AND METHOD FOR MANUFACTURING GARNISH FOR VEHICLE

(71) Applicants: Hyundai Motor Company, Seoul (KR); Kia Motors Corporation, Seoul (KR)

(72) Inventor: Byung Seok KONG, Gunpo-si (KR)

(73) Assignees: Hyundai Motor Company, Seoul (KR); Kia Motors Corporation, Seoul (KR)

(21) Appl. No.: 14/459,954

(22) Filed: Aug. 14, 2014

(30) Foreign Application Priority Data
Dec. 18, 2013 (KR) 10-2013-0158097

(51) Int. Cl. B29C 44/12; B29C 44/34

(52) U.S. Cl. CPC B29C 44/12; B29C 44/3423; B29C 2045/14188

(57) ABSTRACT

Disclosed are an apparatus and a method for manufacturing a garnish for a vehicle. The apparatus may include a movable member configured to form a cavity, a fixed member configured to include a machining part for foaming a thermo plastic olefin (PTO) at a time of being combined with the movable member and a resin supply hole penetrating through the machining part, and a resin supplier configured to supply a melting resin containing a chemical foaming agent to the resin supply hole.

### CROSS REFERENCE TO RELATED APPLICATION

The present application claims priority of Korean Patent Application Number 10-2013-0158097 filed on Dec. 18, 2013, the entire contents of which application are incorporated herein for all purposes by this reference.

### BACKGROUND OF INVENTION

1. Field of Invention

The present invention relates to an apparatus and a method for manufacturing a garnish for a vehicle, and more particularly, to an apparatus and a method for manufacturing a garnish for a vehicle by integrally molding a thermo plastic olefin (PTO) foil and a melting resin.

2. Description of Related Art

Generally, a car body is provided with a garnish which is used as a decoration of the car body as well as protects a surface of the car body from external obstacles. The garnish may cover a joined portion, a welded portion, and the like of a screw and a bolt, clearly treat an appearance, and improve a sense of stability and luxuriousness of the car body and may include a door garnish, a tail gate garnish, a bonnet garnish, a loop garnish, and the like.

The above-mentioned garnish may be manufactured by using a material which has excellent moldability, sufficient elastic force, and small contractile force after being molded. Further, when the finished garnish is mounted at a required portion of a car body panel, the garnish may be manufactured by using a material which prevents a lifting phenomenon from the car body panel and sufficiently fills a gap therebetween.

To this end, as a material of the garnish, a thermo plastic olefin (PTO) foil is mainly used. FIG. 1 illustrates a method for manufacturing a garnish using the PTO foil. That is, the garnish is manufactured by putting a PTO foil 1, which does not have an embo and is not foamed, between a movable type 2 formed with an embo 2a and a fixed type 3 and injecting a melting resin 4 into a rear surface of the PTO foil 1 in the state in which the movable type 2 is combined with the fixed type 3. In this case, the PTO foil 1 is foamed by heat of the melting resin, a front surface of the PTO foil 1 is formed with the embo by the embo 2a of the movable type 2, and the PTO foil 1 is integrally bonded to a resin at the time of hardening the melting resin 4, such that a finished garnish 5 may be manufactured.

The garnish 5 manufactured as described above has a sense of touch of a skin layer more excellent than an existing high elastic coating product and does not require a separate bonding process to be able to reduce the number of processes and improve productivity.

However, when the garnish 5 is manufactured by the above-mentioned method, a sink mark may occur at portions 5a at which a thickness of the product varies and a mark may occur at a position of a valve pin 6 into which the melting resin 4 is injected due to the heat of the resin.

Further, as the garnish 5 manufactured as described above has an end 5b formed in a straight shape, the end of the garnish 5 is wound by adding a separate winding process later, such that the number of processes may be increased, productivity may be reduced, and costs may be increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an apparatus and a method for manufacturing a garnish for a vehicle capable of preventing a sink mark or scratches such as a mark due to heat of a resin from occurring during a manufacturing of the garnish for the vehicle using a PTO foil and a plastic melting resin and improving a quality of the manufactured garnish by simultaneously performing a process of winding an end of the garnish within a mold and improving productivity and saving costs by reducing the number of processes.

According to various aspects of the present invention, there is provided an apparatus for manufacturing a garnish for a vehicle, including a movable member configured to form a cavity, a fixed member configured to include a machining part for foaming a thermo plastic olefin (PTO) at a time of being combined with the movable member and a resin supply hole penetrating through the machining part, and a resin supplier configured to supply a melting resin containing a chemical foaming agent to the resin supply hole.

The apparatus for manufacturing a garnish for a vehicle may further include a heating device configured to preheat the PTO foil at a predetermined temperature prior to fixing the PTO foil to the movable member to improve machinability of the PTO foil when the PTO foil is machined using the movable member and the fixed member.

The movable member may be provided with a winding machining block including a winding groove so that the PTO foil is wound in a state in which the movable member is combined with the fixed member, thereby winding an end of the melting resin when the PTO foil is machined while being bonded to the melting resin. The winding machining block may be detachably mounted on the movable member via an ejector pin which is mounted in the movable member.

The apparatus for manufacturing a garnish for a vehicle may further include a slider configured to be mounted at the fixed member via a spring to elastically support the movable member at the time of combining the movable member with the fixed member, wherein a portion of the slider is provided to elastically support the winding machining block.

The fixed member may be provided with a hot blast supply passage supplying a hot blast to the PTO foil so that the PTO foil keeps in an adhering state with the winding groove of the winding machining block prior to supplying the melting resin in the state in which the movable member is combined with the fixed member.

According to various other aspects of the present invention, there is provided a method for manufacturing a garnish for a vehicle, including; preparing a molding to combine a movable member with a fixed member by moving the movable member, to which a PTO foil is fixed, forward; supplying a hot blast to the PTO foil so that a portion of the PTO foil adheres to a winding groove of a winding machining block; supplying a melting resin containing a chemical foaming agent to a rear surface of the PTO foil; releasing the movable member from the fixed member by integrally bonding the PTO foil to the melting resin, moving the movable member backward from the fixed member and taking out a semi-finished garnish from the movable member; and producing a finished garnish by cutting an unnecessary portion of the PTO foil, to which the melting resin is not bonded, from the semi-finished garnish.

The method for manufacturing a garnish for a vehicle may further include preheating the PTO foil at a predetermined temperature prior to fixing the PTO foil to the movable member.

A valve pin may be mounted in the resin supply hole and move backward from an end of the resin supply hole at a controlled speed when the melting resin containing the chemical foaming agent is supplied to the rear surface of the PTO foil, thereby preventing a mark due to heat of the melting resin from occurring.

The movable member may move backward by a predetermined distance to secure a space depending on the chemical foaming of the melting resin after the melting resin containing the chemical foaming agent is supplied to the rear surface of the PTO foil.

When the movable member moves forward to be combined with the fixed member, when the movable member moves backward by a predetermined distance to secure the space depending on the chemical foaming of the melting resin, and when the movable member moves backward to be released from the fixed member, the winding machining block may move along with the movable member. The winding machining block may be separated from the movable member by an operation of the ejector pin to take out the semi-finished garnish from the movable member after the movable member is released from the fixed member.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is view for describing a method for manufacturing a garnish according to the related art;

FIG. 2 illustrates preheating a PTO foil using a heater in an exemplary apparatus and an exemplary method for manufacturing a garnish for a vehicle according to the present invention;

FIG. 3 illustrates fixing the PTO foil in an exemplary apparatus and an exemplary method for manufacturing a garnish for a vehicle according to the present invention;

FIG. 4 illustrates preparing a molding and supplying a hot blast in an exemplary apparatus and an exemplary method for manufacturing a garnish for a vehicle according to the present invention;

FIG. 5 illustrates supplying a resin in an exemplary apparatus and an exemplary method for manufacturing a garnish for a vehicle according to the present invention;

FIG. 6 illustrates moving a valve pin at the time of supplying a resin in an exemplary apparatus and an exemplary method for manufacturing a garnish for a vehicle according to the present invention;

FIG. 7 illustrates moving a movable type backward by a predetermined distance for foaming after the supplying of the resin in an exemplary apparatus and an exemplary method for manufacturing a garnish for a vehicle according to the present invention;

FIG. 8 illustrates releasing in an exemplary apparatus and an exemplary method for manufacturing a garnish for a vehicle according to the present invention;

FIG. 9 illustrates taking out a semi-finished garnish from the movable type in an exemplary apparatus and an exemplary method for manufacturing a garnish for a vehicle according to the present invention;

FIG. 10 illustrates completing the production of the finished garnish after cutting an unnecessary portion of the PTO foil from the semi-finished garnish in an exemplary apparatus and an exemplary method for manufacturing a garnish for a vehicle according to the present invention; and

FIG. 11 is a flow chart illustrating an exemplary method for manufacturing a garnish for a vehicle according to the present invention.

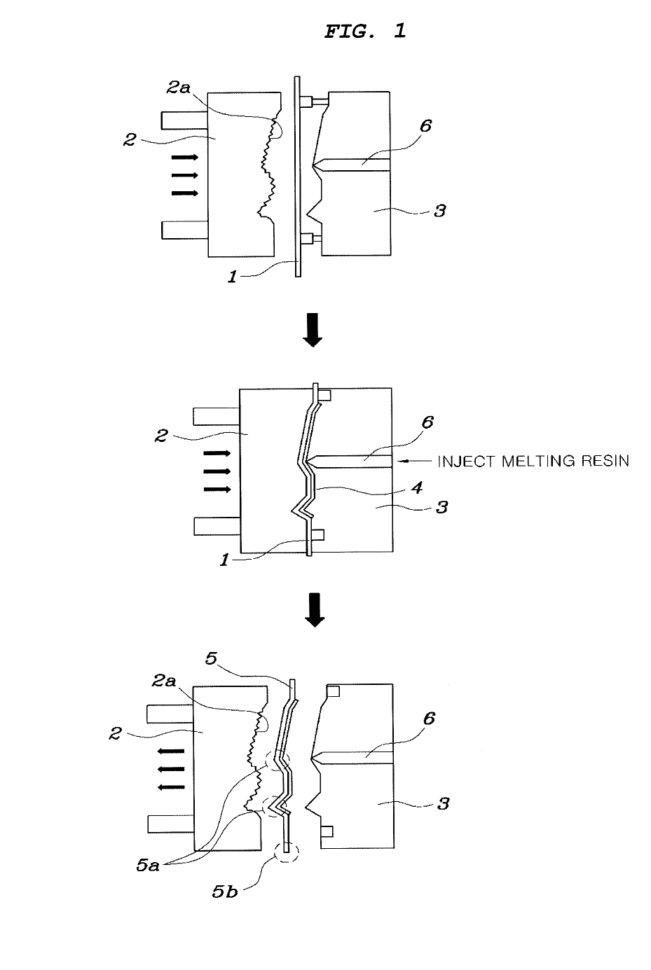

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The apparatus for manufacturing a garnish for a vehicle according to various embodiments of the present invention includes: a heating device 10 configured to preheat a PTO foil 1 at a predetermined temperature to improve machinability of the PTO foil 1; a movable type (e.g., a movable mold, a movable molding part or a movable member) 20 configured to form a cavity 21; a fixed type (e.g., a fixed mold, a fixed molding part, or a fixed member) 30 configured to include a machining part 31 foaming the PTO foil 1 at the time of being combined with the movable type 20 and be provided with a resin supply hole 32 penetrating through the machining part 31; a slider 40 configured to be mounted at the fixed type 20 via a spring 40 to elastically support the movable type 20 at the time of combining the movable type 20 with the fixed type 30; and a resin supplier 50 configured to supply a melting resin 52 containing a chemical foaming agent 51 to the resin supply hole 32.

In this configuration, the heating device 10 may use an electric heater and an inner surface of the movable type 20 forming a cavity 21 may also be provided with an embo, if necessary. When the movable type 20 is provided with the embo, a surface of the garnish manufactured later is provided with the embo, thereby improving a sense of touch of a skin layer.

According to various embodiments of the present invention, the movable type (e.g., a movable mold, a movable molding part or a movable member) 20 is provided with a plurality of fixed pins 22 which may fix the PTO foil 1 preheated by the heating device 10.

Further, according to various embodiments of the present invention, the movable type 20 is further provided with a winding machining block 60 including a winding groove 61 so that the PTO foil 1 may wind an end of the melting resin 52, while enclosing the end of the melting resin 52, when the PTO foil 1 is machined while being bonded to the melting resin 52 in the state in which the movable type 20 is combined with the fixed type 30.

The winding machining block 60 is also provided with a plurality of fixed pins 62 which may fix the PTO foil 1. The winding machining block 60 is provided to be separated from the movable type 20 via an ejector pin 23 which is mounted in the movable type 20. The slider 40 is mounted to elastically support the movable type 20 as well as the winding machining block 60.

The fixed type (e.g., a fixed mold, a fixed molding part, or a fixed member) 30 is further provided with a hot blast supply passage 33 supplying a hot blast to the PTO foil 1 so that the PTO foil 1 may keep an adhering state with a winding groove 61 of the winding machining block 60 prior to supplying the melting resin 52 in the state in which the movable type 20 is combined with the fixed type 30.

The method for manufacturing a garnish for a vehicle according to various embodiments of the present invention includes: preparing a molding to combine the movable type 20 with the fixed type 30 by moving the movable type 20, to which the PTO foil 1 is fixed, forward; supplying the hot blast to the PTO foil 1 so that a portion of the PTO foil 1 adheres to the winding groove 61 of the winding machining block 60; supplying the melting resin 52 containing a chemical foaming agent 51 to a rear surface of the PTO foil 1; releasing the movable type 20 from the fixed type 30 by integrally bonding the PTO foil 1 to the melting resin 52 and then moving the movable type 20 from the fixed type 30 backward and taking out a semi-finished garnish 70 from the movable type 20; and completing a production of a finished garnish 80 by cutting an unnecessary portion 1a of the PTO foil 1, to which the melting resin 52 is not bonded, from the semi-finished garnish 70.

Further, the method for manufacturing a garnish for a vehicle according to various embodiments of the present invention further includes preheating the PTO foil 1 at a predetermined temperature prior to fixing the PTO foil 1 to the fixed type 20.

Further, according to various embodiments of the present invention, a valve pin 90 mounted in the resin supply hole 32 so as to prevent the mark due to the heat of the melting resin 52 from occurring, when the melting resin 52 containing the chemical foaming agent 51 is supplied to the rear surface of the PTO foil 1, moves backward from an end of the resin supply hole 32 at a controlled speed.

The movable type 20 moves backward by a predetermined distance to secure a space depending on the chemical foaming of the melting resin 52 after the melting resin 52 containing the chemical foaming agent 51 is supplied to the rear surface of the PTO foil 1.

Further, when the movable type 20 moves forward to be combined with the fixed type 30, when the movable type 20 moves backward by a predetermined distance so as to secure the space depending on the chemical foaming of the melting resin 52, and when the movable type 20 moves backward to be released from the fixed type 30, the winding machining block 60 moves along with the movable type 20 and the winding machining block 60 is separated from the movable type 20 by the operation of the ejector pin 23 so as to take out the semi-finished garnish 70 from the movable type 30 after the movable type 20 is released from the fixed type 30.

Hereinafter, the method for manufacturing a garnish for a vehicle according to various embodiments of the present invention will be described.

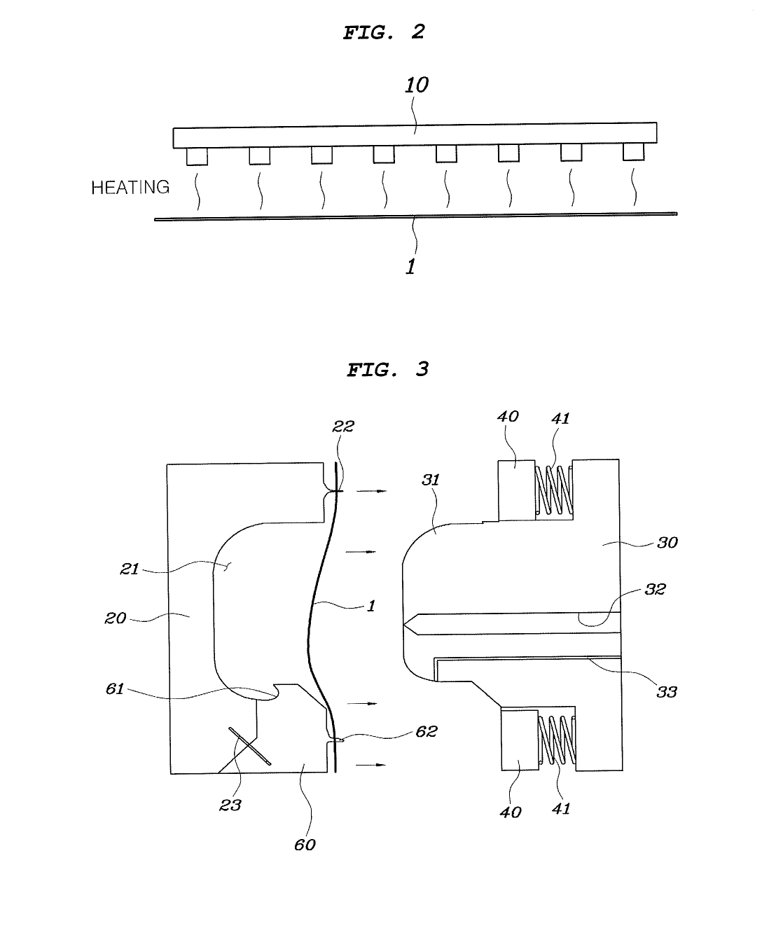

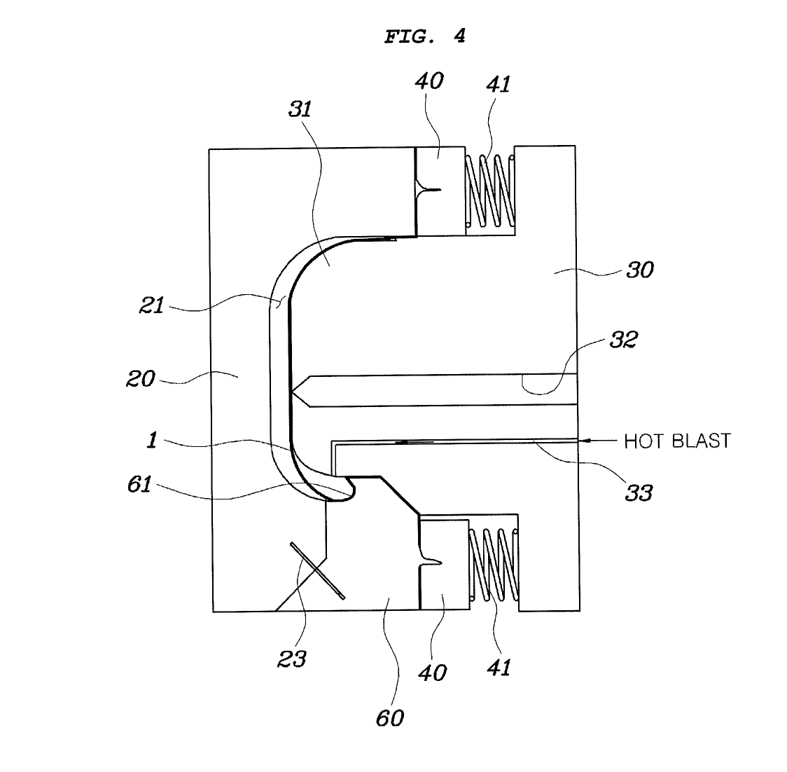

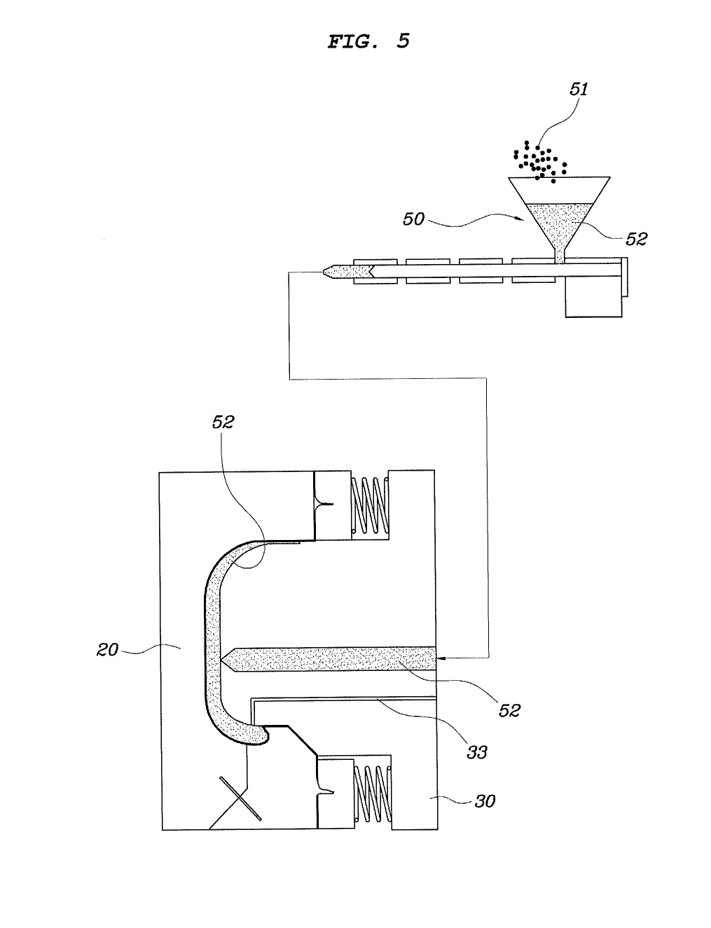

After the PTO foil 1 which is formed without the embo and is not foamed is sufficiently preheated by the heating device 10 (e.g., FIG. 2, step S1 of FIG. 11) and fixed by being inserted into fixed pins 22 and 62 of the movable type 20 and the winding machining block 60 (e.g., FIG. 3, step S2 of FIG. 11), the movable type 20 moves forward to be combined with the fixed type 30 (e.g., FIG. 4, step S3 of FIG. 11).

When the movable type 20 is combined with the fixed type 30, the slider 40 supports the movable type 20 and the winding machining block 60 with an elastic force of the spring 41.

The hot blast is supplied through the hot blast supply passage 33 in the state in which the movable type 20 is combined with the fixed type 30 and a portion of the PTO foil 1 adheres to the winding groove 61 of the winding machining block 60 with the supplied hot blast (e.g., FIG. 4, step S4 of FIG. 11).

The reason why a portion of the PTO foil 1 adheres to the winding groove 61 of the winding machining block 60 by using the hot blast is that the PTO foil 1 is wound, winding the end of the melting resin 52 when the PTO foil 1 is machined, integrally being bonded to the melting resin 52. As a result, there is no need to add the separate winding process.

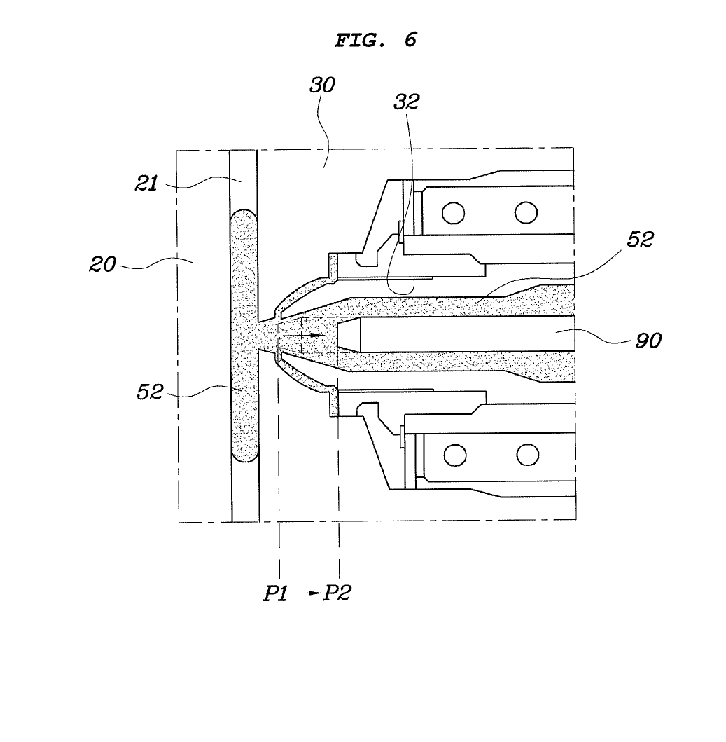

After the hot blast is supplied, the melting resin 52 containing the chemical foaming agent 51 is supplied to the space of the cavity 21 through the rear surface of the PTO foil 1 (e.g., FIG. 5, step S5 of FIG. 11). Herein, when the melting resin 52 containing the chemical foaming agent 51 is supplied to the rear surface of the PTO foil 1, it is possible to prevent the mark due to the heat of the melting resin 52 from occurring. To this end, the valve pin 90 mounted in the resin supply hole 32 gradually moves (position P1→position P2) backward from the end of the resin supply hole 32 (e.g., FIG. 6, step S6 of FIG. 11).

That is, it is possible to prevent the heat of the melting resin 52 from concentrating on the end of the resin supply hole 32 through the retreat movement of the valve pin 90. As a result, it is possible to prevent the mark due to the heat of the resin from occurring at the position of the resin supply hole 32 at the time of hardening the melting resin 52.

Further, when the chemical foaming agent 51 is contained in the melting resin 52, a uniform or substantially uniform pressure is applied to the PTO foil 1 at the time of the foaming of the melting resin 52. As a result, the related art may solve the disadvantage that the sink mark occurs at the portion at which the thickness of the product varies.

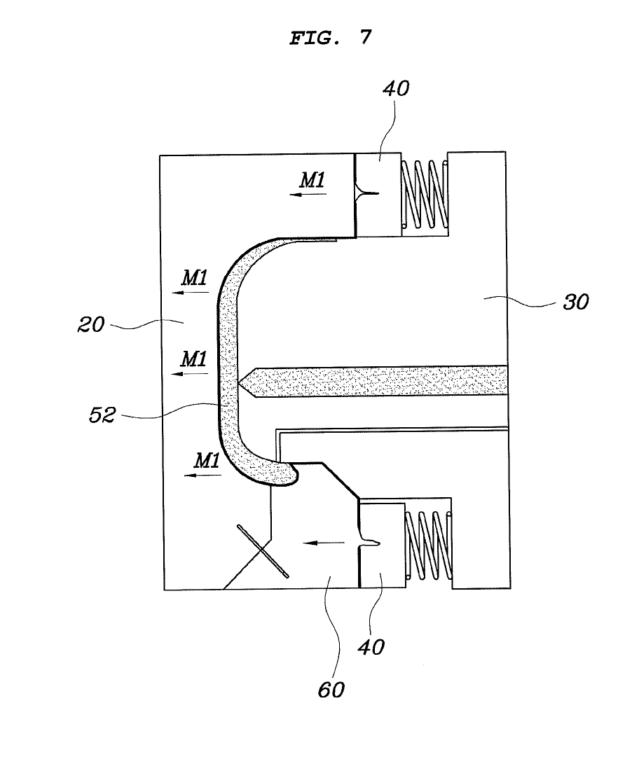

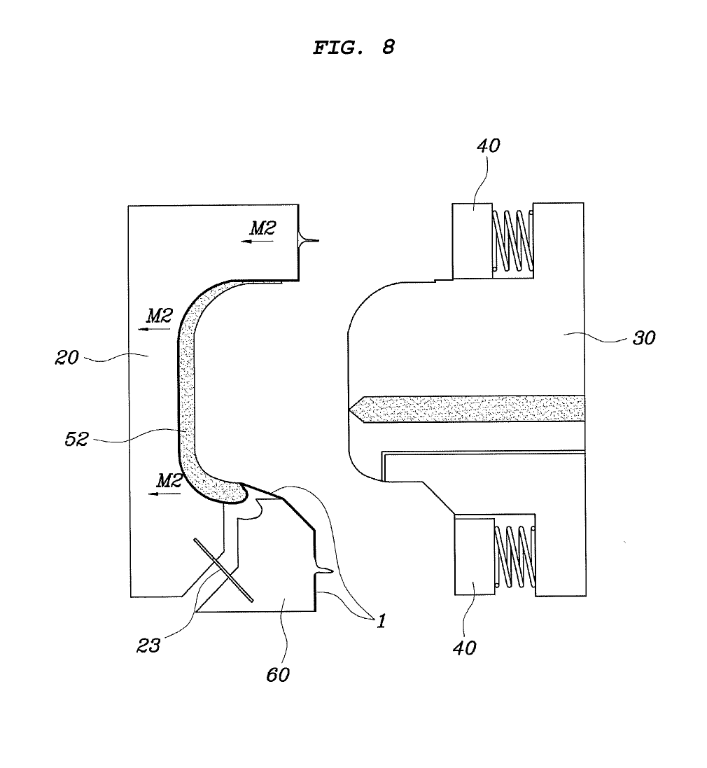

Therefore, after the melting resin 52 containing the chemical foaming agent 51 is supplied to the rear surface of the PTO foil 1, the movable type 20 moves (arrow M1) backward by the predetermined distance to sufficiently secure the space depending on the chemical foaming of the melting resin 52 (e.g., FIG. 7, step S7 of FIG. 11).

Herein, when the movable type 20 moves backward by the predetermined distance, the winding machining block 60 also moves backward and the slider 40 continuously supports the winding machining block 60.

Further, when the melting resin 52 is chemically foamed and then the melting resin 4 is hardened, the PTO foil 1 is integrally bonded to the melting resin 52 (or a component formed by hardening the melting resin 52) and the PTO foil 1 is bonded to the melting resin 52 and then the movable type 20 and the fixed type 30 are in the released state by the retreat movement (arrow M2) of the movable type 20 (e.g., FIG. 8, step S8 of FIG. 11)

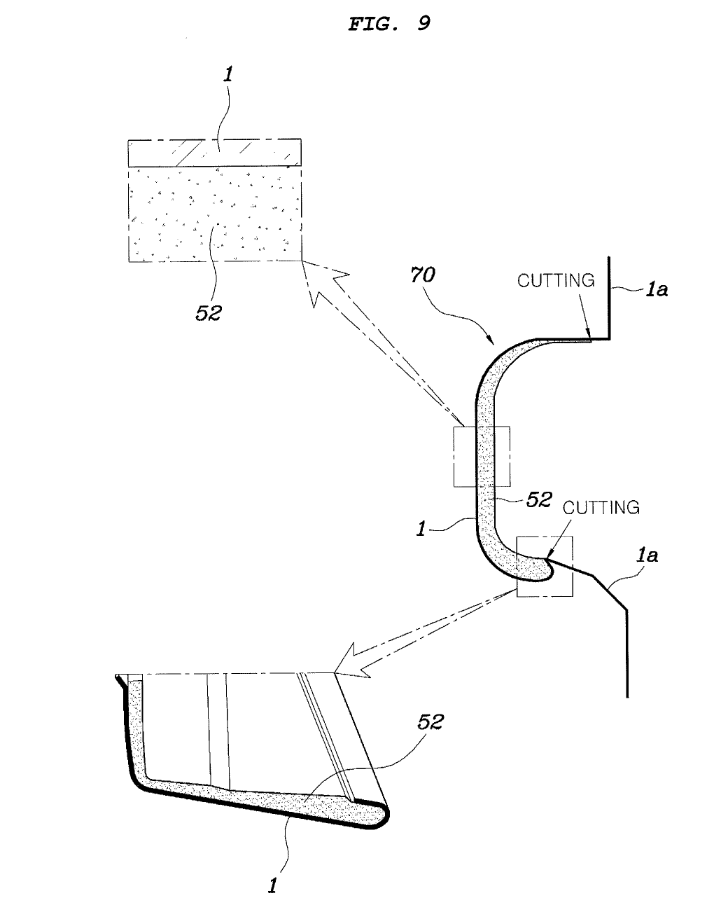

After the movable type 20 and the fixed type 30 are released from each other, the winding machining block 60 is separated from the movable type 20 by the operation of the ejector pin 23 (e.g., FIG. 8) and after the winding machining block 60 is separated from the movable type 20, the semi-finished garnish 70 is taken out from the movable type 20 (e.g., FIG. 9, S9 of FIG. 11).

The semi-finished garnish 70 taken out from the movable type 20 is in the state in which the PTO foil 1 is integrally bonded to the melting resin 52 and has the same appearance as the finished garnish.

Further, in the semi-finished garnish 70, as in the related art, the sink mark does not occur at the portion at which the thickness of the product varies by the action of the chemical foaming agent 51 included in the melting resin 52, the mark due to the heat of the melting resin 52 does not occur at the portion located at the resin supply hole 32 due to the retreat movement of the valve pin 90 at the time of supplying the melting resin 52, and in particular, the portion at which the melting resin 52 ends by the winding machining block 60 is wounded by the PTO foil 1, such that the quality may be improved through the clear finishing and the separate winding process need not be added.

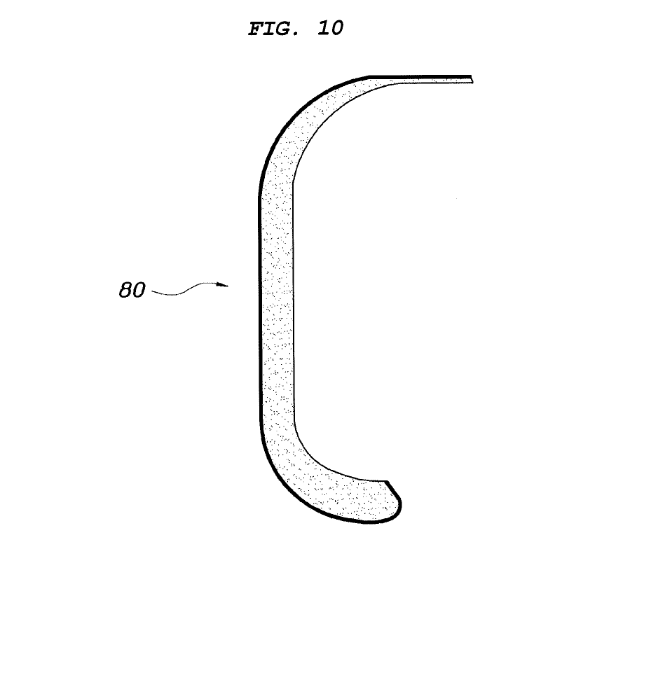

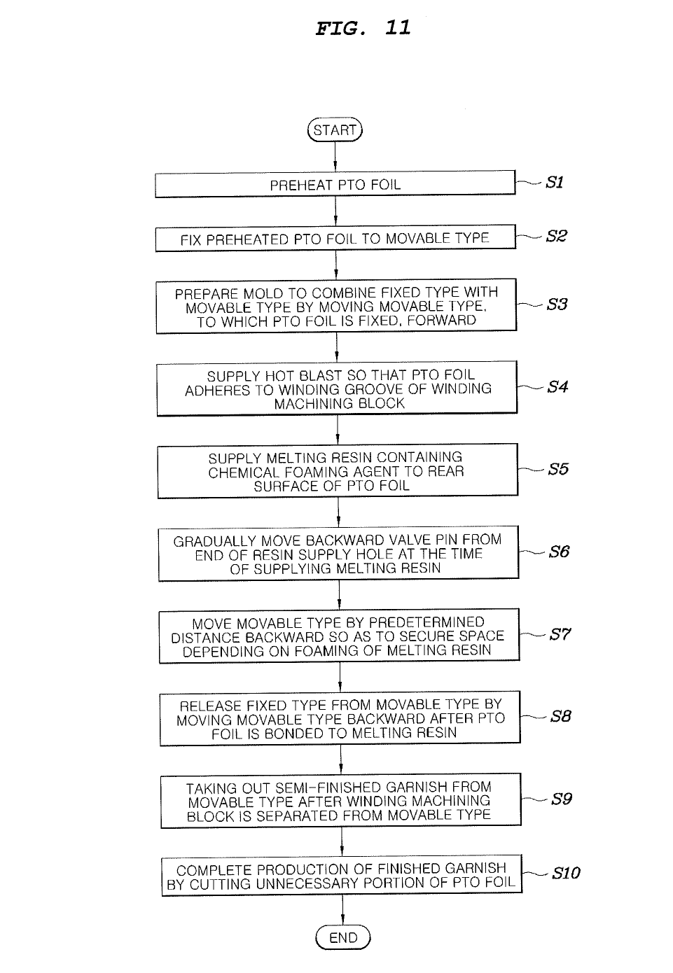

Meanwhile, since the semi-finished garnish 70 includes the unnecessary portion 1a to which the melting resin 52 is not bonded in the PTO foil 1, the unnecessary portion 1a of the PTO foil 1 is cut by the following cutting process, thereby completing the production of the finished garnish 80 (e.g., FIG. 10, step S10 of FIG. 11).

According to various embodiments of the present invention, it is possible to prevent the sink mark or the scratches, such as a mark, due to the heat of the resin from occurring during the manufacturing of the garnish for the vehicle using the PTO foil and the plastic melting resin and in particular, it is possible to improve the quality of the manufactured garnish by simultaneously performing the process of winding the end of the garnish within the mold molding the garnish and reduce the number of processes by not adding the separate winding process to improve productivity and save costs.

As described above, according to various embodiments of the present invention, it is possible to prevent the scratches, such as the sink mark, from occurring at the portion at which the thickness of the product varies during the manufacturing of the garnish for the vehicle using the PTO foil and the plastic melting resin, the mark due to the heat of the resin from occurring at the portion which coincides with the resin supply hole, and in particular, it is possible to improve the quality of the manufactured garnish by simultaneously performing the process of winding the end of the garnish within the mold molding the garnish and reduce the number of processes by not adding the separate winding process to improve productivity and save costs.

For convenience in explanation and accurate definition in the appended claims, the terms “front” or “rear”, “inner” or “outer”, “forward” or “backward”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for manufacturing a garnish for a vehicle, the apparatus comprising:
a movable member configured to form a cavity;
a fixed member configured to include a machining part for foaming a thermo plastic olefin (PTO) at a time of being combined with the movable member and a resin supply hole penetrating through the machining part; and
a resin supplier configured to supply a melting resin containing a chemical foaming agent to the resin supply hole.

2. The apparatus of claim 1, further comprising:
a heating device configured to preheat the PTO foil at a predetermined temperature prior to fixing the PTO foil to the movable member to improve machinability of the PTO foil when the PTO foil is machined using the movable member and the fixed member.

3. The apparatus of claim 2, wherein the movable member is provided with a winding machining block including a winding groove so that the PTO foil is wound in a state in which the movable member is combined with the fixed member, thereby winding an end of the melting resin when the PTO foil is machined while being bonded to the melting resin.

4. The apparatus of claim 3, wherein the winding machining block is detachably mounted on the movable member via an ejector pin which is mounted in the movable member.

5. The apparatus of claim 3, further comprising:
a slider configured to be mounted at the fixed member via a spring to elastically support the movable member at the time of combining the movable member with the fixed member,
wherein a portion of the slider is provided to elastically support the winding machining block.

6. The apparatus of claim 3, wherein the fixed member is provided with a hot blast supply passage supplying a hot blast to the PTO foil so that the PTO foil keeps in an adhering state with the winding groove of the winding machining block prior to supplying the melting resin in the state in which the movable member is combined with the fixed member.

7. A method for manufacturing a garnish for a vehicle, comprising:
preparing a molding to combine a movable member with a fixed member by moving the movable member, to which a PTO foil is fixed, forward;
supplying a hot blast to the PTO foil so that a portion of the PTO foil adheres to a winding groove of a winding machining block;
supplying a melting resin containing a chemical foaming agent to a rear surface of the PTO foil;
releasing the movable member from the fixed member by integrally bonding the PTO foil to the melting resin, moving the movable member backward from the fixed member and taking out a semi-finished garnish from the movable member; and
producing a finished garnish by cutting an unnecessary portion of the PTO foil, to which the melting resin is not bonded, from the semi-finished garnish.

8. The method of claim 7, further comprising:
preheating the PTO foil at a predetermined temperature prior to fixing the PTO foil to the movable member.

9. The method of claim 7, wherein a valve pin is mounted in the resin supply hole and moves backward from an end of the resin supply hole at a controlled speed when the melting resin containing the chemical foaming agent is supplied to the rear surface of the PTO foil, thereby preventing a mark due to heat of the melting resin from occurring.

10. The method of claim 7, wherein the movable member moves backward by a predetermined distance to secure a space depending on the chemical foaming of the melting resin after the melting resin containing the chemical foaming agent is supplied to the rear surface of the PTO foil.

11. The method of claim 10, wherein when the movable member moves forward to be combined with the fixed member, when the movable member moves backward by a predetermined distance to secure the space depending on the chemical foaming of the melting resin, and when the movable member moves backward to be released from the fixed member, the winding machining block moves along with the movable member; and
the winding machining block is separated from the movable member by an operation of the ejector pin to take out the semi-finished garnish from the movable member after the movable member is released from the fixed member.
